(19) United States
(12) Patent Application Publication
(10) Pub. No.: US 2010/0258488 A1
(43) Pub. Date: Oct. 14, 2010

(54) LIQUID-CONDUCTING HOLLOW CROSS-SECTION

(76) Inventor: Michael Braunheim, Goppingen (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/743,086

(22) PCT Filed: Oct. 24, 2008
(86) PCT No.: PCT/EP2008/064426

§ 371 Date: May 14, 2010

(30) Foreign Application Priority Data
Nov. 16, 2007 (DE) 10 2007 054 770.8

(51) Int. Cl. B01D 29/88; F02M 37/22

(52) U.S. Cl. 210/109

(57) ABSTRACT

A liquid-conducting hollow cross-section liquid discharge line, including a liquid having temperature-dependent volume changes, wherein the liquid solidifies under certain temperature conditions, and wherein the hollow cross-section includes at least one displacement element, the displacement element reduces the free cross-section available for a liquid; and wherein the discharge line is in a fuel filter system.

The present invention relates to a liquid-conducting hollow cross-section, in particular a water-conducting line, according to the preamble of a claim 1. Furthermore, the invention relates to a fuel filter equipped with such a hollow cross-section.

Hollow cross-section which conduct or convey liquids are well known, for example as water lines. If the liquids conducted within the hollow cross-section show temperature-dependent volume changes, that is, if there is a risk for the liquid conducted in the hollow cross-section of solidification or freezing when the temperature falls below a certain value, this transition from the liquid state to the solid state of aggregation, which typically involves a volume increase, can result in a burst pressure within the hollow cross-section which, in particular in case of water, can easily cause a burst of the hollow cross-section, namely when the hollow cross-section is not able to compensate for the volume increase of the solidifying liquid by a change of its size. Hollow cross-sections which are exposed to the weather, for example in a motor vehicle, and which contain a liquid at risk of freezing, must be protected, for example, by means of an antifreeze agent against freezing of the liquid and thus against damage of the hollow cross-section. If this is not possible for hygienic reasons, for example in case of a drinking water line, the same has to be protected against freezing in a different manner, for example by laying the lines below the frost line. However, in particular in this case there is principally the possibility of damage if the liquid, here in particular water, freezes within the hollow cross-section.

The present invention is concerned with the problem to design a generic liquid-conducting hollow cross-section in such a manner that a solidification or freezing of a liquid conducted within the hollow cross-section can not result in a damage of the hollow cross-section.

This problem is solved according to the invention by the subject matters of the independent claims. Advantageous embodiments are subject matter of the dependent claims.

The invention is based on the general idea to provide in a hollow cross-section conducting a liquid at risk of freezing, a displacement element that reduces a free cross-section available for the liquid. If the transport cross-section available for the liquid is intended to be same as the one of a conventional hollow cross-section, that is, a hollow cross-section without a displacement element, then, in principle, the hollow cross-section has to be formed larger. Forming an increased cross-section of the hollow cross-section results in an increase of the circumference and of an inner casing surface of the hollow cross-section. Since for the same volume of liquid, the same volume increase for the same takes place during freezing, the required adaption of the size of the hollow cross-section with the displacement element to the volume increase of the solidifying liquid is distributed over a larger inner casing surface compared to a conventional smaller hollow cross-section. The minor change of size per surface means lower strain in the material of the hollow cross-section according to the invention. Since the stress in the material is proportional to strain, the stress in the material of the hollow cross-section according to the invention is reduced compared to the stress in conventional hollow cross-sections. For this, the displacement element is preferably selected with respect to its volume in such a manner that the stress which is generated during freezing of the liquid and which acts on the hollow cross-section can be absorbed by the latter without any problems. Damage to the hollow cross-section during freezing of the liquid conducted therein can therefore be reliably excluded. Moreover, such a displacement element can be manufactured in a constructionally simple and inexpensive manner so that almost any hollow cross-sections with almost any liquid conducted therein can be made frost-proof. This is in particular of great advantage with respect to hollow cross-sections for which bursting of the same caused by freezing of the liquid transported therein must absolutely be excluded. An example for this can be a water-discharging line from a diesel fuel filter which, when bursting, would cause that diesel fuel escapes into the environment thereby polluting the same. Of course, the term hollow cross-section is to be interpreted in a flexible manner so that containers, pipe systems, etc. can also be understood as hollow cross-sections.

In a further advantageous embodiment of the solution according to the invention, the displacement element is formed in a reversibly compressible manner. This offers another advantage because the volume increase generated during freezing of the liquid can be absorbed by a volume reduction of the displacement element. Once the liquid in the hollow cross-section exceeds its melting point, the reversible, compressible displacement element can expand again to its original size. As an example for such reversibly compressible displacement elements, for example, balloon-like displacement elements which enclose a gas volume can be mentioned.

Advantageously, the at least one displacement element has a circular cross-section and is arranged coaxially in the hollow cross-section which also has a circular cross-section. For this, it can be provided that the displacement element extends over the entire axial length of the hollow cross-section or only over portions of the axial length, wherein the size of the displacement elements to be provided depends on the liquid transported within the hollow cross-section and on the stress that can be absorbed by the hollow cross-section during the solidification or freezing of the liquid. It is conceivable here that the displacement element, which is arranged coaxially within the cylindrical hollow cross-section, is kept in its coaxial position by means of suitable ribs or positioning elements, wherein it is irrelevant for the physical effect of the invention if the displacement element is arranged coaxially or eccentrically within the hollow cross-section. In both cases, damage to the hollow cross-section caused by solidification or freezing of the liquid can be reliably prevented.

Further features and advantages of the invention arise from the sub-claims, from the drawings, and from the associated description of the figures by means of the drawings.

It is to be understood that the above mentioned features and the features yet to be explained hereinafter can be used not only in the respectively mentioned combination, but also in other combinations or alone without departing from the scope of the present invention.

Preferred exemplary embodiments of the invention are illustrated in the drawings and are explained in more detail hereinafter, wherein identical reference numbers refer to identical, or similar, or functionally identical components.

In the figures:

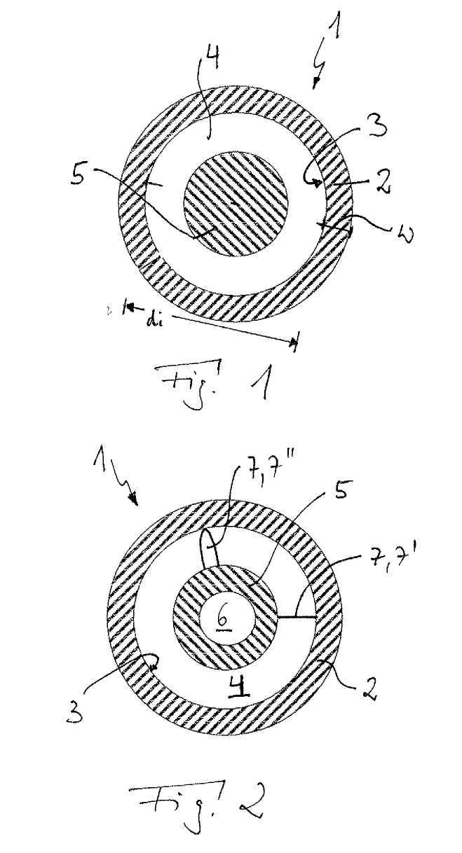

FIG. 1 shows schematically a section through a hollow cross-section with a displacement element according to the invention,

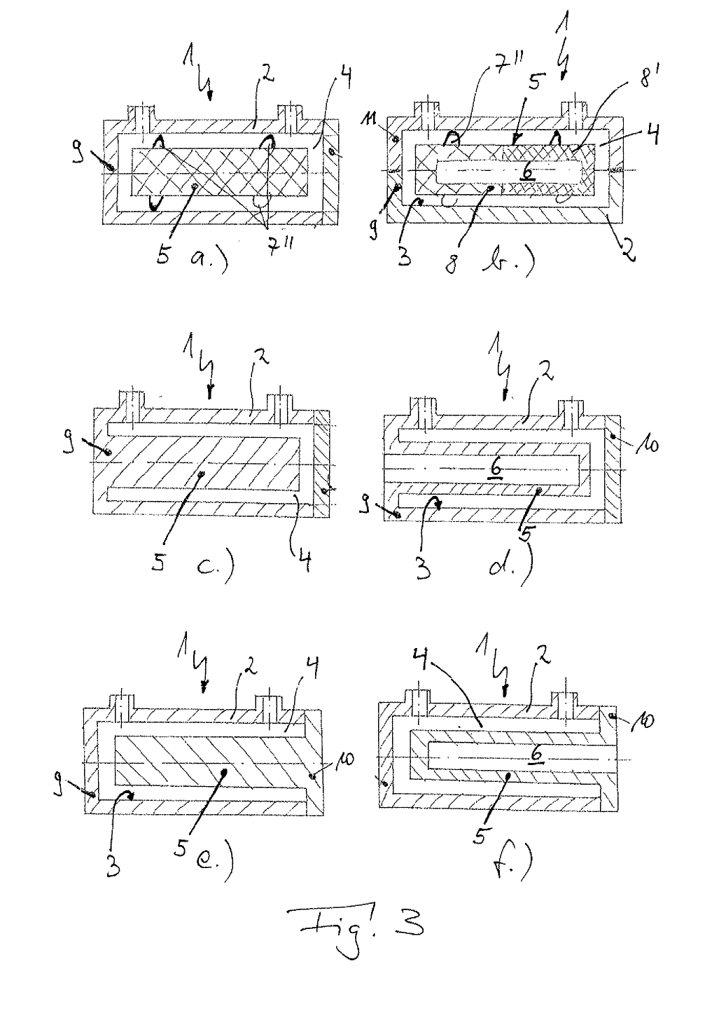

FIG. 2 shows schematically an illustration like the one of FIG. 1, but with a differently equipped displacement element,

FIG. 3a-f show schematically different embodiments of displacement elements arranged in the hollow cross-section.

According to FIG. 1, a liquid-conducting hollow cross-section 1 according to the invention has a casing 2 with an inner casing surface 3. The liquid 4 transported within the hollow cross-section 1 shows a temperature-dependent volume change, in particular, the liquid 4 can solidify or freeze, that is, it can change from a liquid to a solid aggregate state with volume increase when the temperature falls below a certain value. The liquid 4, for example, can be water, wherein in this case, the hollow cross-section 1 represents a water line. According to the invention, in the hollow cross-section 1, at least one displacement element 5 is provided which is illustrated according to FIGS. 1 and 2 without hatching and which reduces the free cross-section available for the liquid 4. Here, the displacement element 5 has a circular cross-section and is arranged coaxially in the hollow cross-section 1 which also has a circular cross-section. The displacement element 5 having a circular cross-section represents only one possible embodiment so that it is, of course, also possible that it has a complex cross-section which is, for example, not circular and which is arranged in a circular or complex (non-circular) hollow cross-section 1.

Because of the insertion of the displacement element 5 in the hollow cross-section 1, an inner diameter dᵢ of the hollow cross-section 1 has to be larger than the one of a comparable line without a displacement element 5 to obtain the same flow cross-section in both lines. With the increased inner diameter dᵢ, the inner circumference of the inner casing surface 3 and the outer circumference of the hollow cross-section 1 increase as well. If now a transition of the liquid 4 from a liquid to a solid aggregate state takes place, as this is the case, for example, when water freezes, the volume increase is the same as for a hollow cross-section 1 without displacement element 5; however, due to the increased inner circumference of the inner casing surface 3, more surface area is available that can adapt to the volume increase of the solidifying liquid. Assuming that for liquids 4 with the same volume, the volume increase is the same, then the stress σ [N/mm²] acting within the casing 2 is significantly smaller due to the larger surface, whereby for the hollow cross-section 1 according to the invention, bursting of the casing 2 and thus leaking of the hollow cross-section 1 very likely can be avoided or completely excluded.

Of course, it is also conceivable that the displacement element 5 does not have—as illustrated in FIG. 1—a solid cross-section but preferably encloses a hollow space 6 filled with gas. Such a displacement element 5 is thus designed to be considerably lighter than a comparable displacement element 5 with a solid cross-section. For a displacement element 5 as it is shown in FIG. 2, it is also conceivable that it is reversibly compressible and thereby, during solidification or freezing of the liquid 4, is capable to absorb the volume increase of the freezing or solidifying liquid 4 through a volume reduction. In this case, a wall thickness w of the casing 2 can be formed thinner.

Of course, the designation hollow cross-section 1 is to be understood as purely exemplary so that the drawn hollow cross-sections 1 can also involve different types of line systems, containers etc. All hollow cross-sections 1 according to the invention have in common, however, that by providing the displacement element 5, the risk of frost damage, in particular bursting of the casing 2 of the hollow cross-section 1, can be reduced or preferably completely excluded.

According to FIG. 2, the at least one displacement element 5 has at least one positioning element 7 by means of which it is retained on the inner casing surface 3 of the casing 2. For this purpose, the positioning element 7 can be formed, for example, as rib 7′ or positioning lug 7″. According to FIG. 2, the positioning element 7 keeps the displacement element 5 in a coaxial position with respect to the hollow cross-section 1. However, for the functionality of the hollow cross-section according to the invention, a coaxial positioning of the displacement element 5 is not required.

Also, by means of the displacement element 5, such hollow cross-sections 1 can be made frost-proof which, in case of bursting, would subsequently allow the liquid 4 to escape into the environment thereby causing a contamination of the same. Such a contamination could take place, for example, when the hollow cross-section 1 is designed as water outlet of a fuel filter. If, due to the freezing water, the casing 2 of the hollow cross-section 1 would break, fuel carried along in the discharged water could get into the environment thereby polluting the same. Of course, it is essential to avoid the latter, whereby the hollow cross-section 1 according to the invention is in particular suitable for usage in such a field of use.

According to FIGS. 3a to 3f, different embodiments of displacement elements 5 are illustrated, wherein according to FIGS. 3a, c, and e, the displacement element 5 is formed as solid cross-section. For example, the displacement elements 5 according to FIGS. 3 and 3b are kept in position by means of the positioning lugs 7″.

In comparison to FIG. 3a, the displacement element 5 according to FIG. 3b has a hollow space 6 and, moreover, consists of two half-shells 8 and 8′ which are, for example screwed together or welded together. It is conceivable here, that the materials of the two half-shells 8 and 8′ involve the same materials or different materials, it is in particular conceivable that one of the two half-shells 8 or 8′ is formed from a compressible material. In this exemplary embodiment, the hollow cross-section 1 is formed by the hollow cross-section walls 9 and 11.

According to FIGS. 3c and 3d, the displacement element 5 is designed as one piece with a hollow cross-section wall 9 or formed as one piece with the same. Moreover, the displacement element 5 according to FIG. 3d has a hollow space 6 which, in contrast to the hollow space 6 of the displacement element 5 illustrated in FIG. 3b, is formed into the environment, that is, open towards the outside.

According to FIGS. 3e and 3f, the displacement element 5 is formed as one piece with a cover 10 of the hollow cross-section 1 formed as a container. The hollow space 6 of the displacement element 5 according to FIG. 3f is also open towards the outside whereas the displacement element 5 according to FIG. 3e is formed as a solid profile, that is, without a hollow space 6.

By means of the displacement element 5 according to the invention it is possible to make different liquid-conducting hollow cross-sections 1 frost-proof and to reliably exclude, even in case of strong frost, that liquid can escape. This is in particular of advantage for a hollow cross-section 1 in which liquids 4 are transported which would contaminate the environment when leaking to the outside.

1. A liquid-conducting hollow cross-section, comprising:
a liquid having at least one temperature-dependent volume change, wherein the at least one temperature-dependent volume change is solidification;
wherein the hollow cross-section includes at least one displacement element, the displacement element reducing the free cross-section available for a liquid; and
wherein the hollow cross-section is a water discharge line in a diesel fuel filter system.

2. The hollow cross-section according to claim 1, wherein the at least one displacement element has a circular cross-section and is arranged coaxially in the hollow cross-section.

3. The hollow cross-section according to claim 1, wherein the displacement element is fixed on the hollow cross-section by at least one means of radial ribs.

4. The hollow cross-section according to claim 1, wherein the displacement element is formed as a solid profile.

5. The hollow cross-section according to claim 1, wherein the displacement element is formed as a hollow profile, and wherein a connection can be provided between a hollow space within the displacement element and the environment.

6. The hollow cross-section according to claim 1, wherein the hollow cross-section is formed as a container.

7. The hollow cross-section according to claim 1, wherein the displacement element is reversibly compressible.

8. The hollow cross-section according to claim 1, wherein the at least one displacement element includes at least one positioning element, which keeps the displacement element at a predetermined position within the hollow cross-section.

9. A fuel filter, comprising: a hollow cross-section; and at least one generally circular displacement element fixedly positioned at a predetermined point within the hollow cross-section by at least one rib, wherein the hollow cross-section discharges at least a water separated from a fuel.

10. The fuel filter according to claim 9, wherein the water has a temperature-dependent volume change, wherein the temperature-dependent volume changes is solidification from freezing.

11. The fuel filter according to claim 9, wherein the hollow cross-section corresponds to the shape of the displacement element.

12. The fuel filter according to claim 9, wherein the at least one displacement element is arranged coaxially in the hollow cross-section

13. The fuel filter according to claim 9, wherein the displacement element is formed as a solid profile.

14. The fuel filter according to claim 9, wherein the displacement element is formed as a hollow profile, and wherein a connection can be provided between a hollow space within the displacement element and the environment.

15. The fuel filter according to claim 9, wherein the hollow cross-section is formed as a container.

16. The fuel filter according to claim 9, wherein the displacement element is reversibly compressible.

17. The hollow cross-section according to claim 1, wherein the solidification is a frozen liquid.

18. The hollow cross-section according to claim 1, wherein the hollow cross-section is at least generally circular.

19. The diesel fuel filter according to claim 2, wherein the displacement element is fixed on the hollow cross-section by at least one radial rib.

20. The diesel fuel filter according to claim 2, wherein the displacement element is formed as a solid profile.
